(19) United States
(12) Patent Application Publication
(10) Pub. No.: US 2026/0205273 A1
(43) Pub. Date: Jul. 16, 2026

(54) METHOD AND APPARATUS FOR PROCESSING LOG, DEVICE, AND PRODUCT

(71) Applicant: Beijing Zitiao Network Technology Co., Ltd., Beijing (CN)

(72) Inventors: Cong Liu, Beijing (CN); Hao Zhao, Beijing (CN); Jianping Wu, Beijing (CN); Yonghao Yi, Beijing (CN); Xing Yao, Beijing (CN)

(21) Appl. No.: 19/452,065

(22) Filed: Jan. 16, 2026

(30) Foreign Application Priority Data
Jan. 16, 2025 (WO) PCT/CN2025/072749

(51) Int. Cl. H04L 9/08; H04L 9/30

(52) U.S. Cl. CPC H04L 9/0825; H04L 9/30

(57) ABSTRACT

The present disclosure relates to a method and apparatus for processing a log, a device, and a product. The method includes receiving an encrypted log from a client, where an encryption process of the encrypted log is associated with a first key bound to a first time point. The method further includes determining, in response to receiving an access request for the encrypted log at a second time point, a time difference between the first time point and the second time point, where the second time point is later than the first time point. Additionally, the method further includes using, in response to the time difference being less than a preset time window length, a second key to decrypt the encrypted log, where the second key is the same as or corresponds to the first key.

### CROSS-REFERENCE TO RELATED APPLICATION(S

This application claims priority to PCT Application No. PCT/CN2025/072749 filed on January 16, 2025, the disclosure of which is incorporated herein by reference in its entity.

### FIELD

The present disclosure relates to the field of data security, and more specifically, to a method and apparatus for processing a log, a device, and a product.

### BACKGROUND

With the rapid development of the mobile Internet, mobile applications have become an indispensable part of daily lives of users. For example, video applications have not only profoundly changed the entertainment way of people but have also become important platforms for various activities such as information dissemination, social interaction, and creative expression. More and more users share life experiences and showcase personal talents through the video applications, enriching the content of digital lives.

The mobile applications generate a large amount of log data during operation, including but not limited to system information, operation records, application performance data, network communication data, as well as error and exception data, etc. If the data is not collected securely and used appropriately, it may lead to data leakage or misuse, thereby posing a threat to data security.

### SUMMARY

In a first aspect of embodiments of the present disclosure, a method for processing a log is provided. The method includes receiving an encrypted log from a client, where an encryption process of the encrypted log is associated with a first key bound to a first time point. The method further includes determining, in response to receiving an access request for the encrypted log at a second time point, a time difference between the first time point and the second time point, where the second time point is later than the first time point. Additionally, the method further includes using, in response to the time difference being less than a preset time window length, a second key to decrypt the encrypted log, where the second key is the same as or corresponds to the first key.

In a second aspect of the embodiments of the present disclosure, another method for processing a log is provided. The method includes generating a log. The method further includes acquiring a first key, where the first key is bound to a first time point. The method further includes using, based on the log, the first key to generate an encrypted log. Additionally, the method further includes sending the encrypted log to a server side, where a second key used by the server side for decrypting the encrypted log is expired at a second time point, a time difference between the first time point and the second time point is greater than a preset time window length, and the second key is the same as or corresponds to the first key.

In a third aspect of the embodiments of the present disclosure, an apparatus for processing a log is provided. The apparatus includes an encrypted log receiving module, configured to receive an encrypted log from a client, where an encryption process of the encrypted log is associated with a first key bound to a first time point. The apparatus further includes a time difference determination module, configured to determine, in response to receiving an access request for the encrypted log at a second time point, a time difference between the first time point and the second time point, where the second time point is later than the first time point. Additionally, the apparatus further includes a log decryption module, configured to use, in response to the time difference being less than a preset time window length, a second key to decrypt the encrypted log, where the second key is the same as or corresponds to the first key.

In a fourth aspect of the embodiments of the present disclosure, another apparatus for processing a log is provided. The apparatus includes a log generation module, configured to generate a log. The apparatus further includes a key acquiring module, configured to acquire a first key, where the first key is bound to a first time point. The apparatus further includes a log encryption module, configured to use, based on the log, the first key to generate an encrypted log. Additionally, the apparatus further includes a log sending module, configured to send the encrypted log to a server side, where a second key used by the server side for decrypting the encrypted log is expired at a second time point, a time difference between the first time point and the second time point is greater than a preset time window length, and the second key is the same as or corresponds to the first key.

In a fifth aspect of the embodiments of the present disclosure, an electronic device at a server side is provided. The electronic device includes one or more processors; and a storage apparatus, configured to store one or more programs. The one or more programs, when executed by the one or more processors, cause the one or more processors to implement a method for processing a log. The method includes receiving an encrypted log from a client, where an encryption process of the encrypted log is associated with a first key bound to a first time point. The method further includes determining, in response to receiving an access request for the encrypted log at a second time point, a time difference between the first time point and the second time point, where the second time point is later than the first time point. Additionally, the method further includes using, in response to the time difference being less than a preset time window length, a second key to decrypt the encrypted log, where the second key is the same as or corresponds to the first key.

In a sixth aspect of the embodiments of the present disclosure, an electronic device at a client is provided. The electronic device includes one or more processors; and a storage apparatus, configured to store one or more programs. The one or more programs, when executed by the one or more processors, cause the one or more processors to implement a method for processing a log. The method includes generating a log. The method further includes acquiring a first key, where the first key is bound to a first time point. The method further includes using, based on the log, the first key to generate an encrypted log. Additionally, the method further includes sending the encrypted log to a server side, where a second key used by the server side for decrypting the encrypted log is expired at a second time point, a time difference between the first time point and the second time point is greater than a preset time window length, and the second key is the same as or corresponds to the first key.

In a seventh aspect of the embodiments of the present disclosure, a computer program product is provided. The computer program product is tangibly stored on a non-transitory computer-readable medium and includes a machine-executable instruction, and the machine-executable instruction, when executed, causes a machine to implement a method for processing a log. The method includes receiving an encrypted log from a client, where an encryption process of the encrypted log is associated with a first key bound to a first time point. The method further includes determining, in response to receiving an access request for the encrypted log at a second time point, a time difference between the first time point and the second time point, where the second time point is later than the first time point. Additionally, the method further includes using, in response to the time difference being less than a preset time window length, a second key to decrypt the encrypted log, where the second key is the same as or corresponds to the first key.

In an eighth aspect of the embodiments of the present disclosure, a computer program product is provided. The computer program product is tangibly stored on a non-transitory computer-readable medium and includes a machine-executable instruction, and the machine-executable instruction, when executed, causes a machine to implement a method for processing a log. The method includes generating a log. The method further includes acquiring a first key, where the first key is bound to a first time point. The method further includes using, based on the log, the first key to generate an encrypted log. Additionally, the method further includes sending the encrypted log to a server side, where a second key used by the server side for decrypting the encrypted log is expired at a second time point, a time difference between the first time point and the second time point is greater than a preset time window length, and the second key is the same as or corresponds to the first key.

The section SUMMARY is provided to introduce concept selection in a simplified form, which will be further described in the following specific implementations. The section SUMMARY is not intended to identify key or essential features of the subject claimed for protection, nor is it intended to limit the scope of the subject claimed for protection.

### BRIEF DESCRIPTION OF THE DRAWINGS

The above and other features, advantages, and aspects of various embodiments of the present disclosure will become more apparent in combination with the accompanying drawings and with reference to following detailed descriptions. In the accompanying drawings, the same or similar reference numerals denote the same or similar elements.

FIG. 1 illustrates a schematic diagram of an example environment where a plurality of embodiments of the present disclosure may be implemented;

FIG. 2 illustrates a flowchart of a method for processing a log according to some embodiments of the present disclosure;

FIG. 3 illustrates a flowchart of another method for processing a log according to some embodiments of the present disclosure;

FIG. 4 illustrates a schematic diagram of an example of a process of sending an encrypted log to a server side from a client according to some embodiments of the present disclosure;

FIG. 5 illustrates a schematic diagram of an example of a process for periodically checking a timestamp associated with a log at a server side according to some embodiments of the present disclosure;

FIG. 6 illustrates a schematic diagram of an example of a process for processing a log access request at a server side according to some embodiments of the present disclosure;

FIG. 7 illustrates a block diagram of an apparatus for processing a log according to some embodiments of the present disclosure;

FIG. 8 illustrates a block diagram of another apparatus for processing a log according to some embodiments of the present disclosure; and

FIG. 9 illustrates a block diagram of a device capable of implementing a plurality of embodiments of the present disclosure.

### DETAILED DESCRIPTION OF EMBODIMENTS

It should be understood that all user-related data involved in the technical solution should be acquired and used after user authorization, which means that in the technical solution, if personal information of a user needs to be used, explicit consent and authorization from the user are required before acquiring these data, otherwise, relevant data collection and use will not be carried out. It should also be understood that when the technical solution is implemented, relevant laws and regulations should be strictly followed in the process of data collection, use, and storage, and necessary technologies and measures should be taken to ensure the security of user data and the safe use of the data.

The embodiments of the present disclosure will be described in more detail below with reference to the accompanying drawings. Although the accompanying drawings show some embodiments of the present disclosure, it should be understood that the present disclosure may be implemented in various forms, and should not be construed as being limited to the embodiments stated herein. On the contrary, these embodiments are provided for a more thorough and complete understanding of the present disclosure. It should be understood that the accompanying drawings and the embodiments of the present disclosure are for exemplary purposes only, and are not intended to limit the scope of protection of the present disclosure.

In the description of the embodiments of the present disclosure, the term "include" and similar terms thereof should be understood as open-ended inclusions, namely, "including but not limited to". The term "based on" should be understood as "at least partially based on". The term "an embodiment" or "this embodiment" should be understood as "at least one embodiment". The terms "first", "second", etc. may refer to different or identical objects, unless otherwise explicitly specified. Other explicit and implicit definitions may also be included below.

Mobile applications generate a large amount of log data during operation, including but not limited to system information, operation records, application performance data, network communication data, as well as error and exception data, etc. To analyze an operational state and the operation records of the applications, application logs are typically stored at a server side for access by a data analysis system. The logs are usually generated by a client and collected to the server side through methods such as a log agent tool (e.g., Fluentd and Logstash), an application programming interface (API), or a message queue (e.g., Kafka and RabbitMQ). At the server side, the logs may be stored using a file storage, a database, and a cloud-based object storage.

In some related art, the logs are stored at the server side for a long term after being anonymized. However, the anonymized logs may still include data associated with the user. If the data is stored for a long term without desensitization processing, once a security vulnerability or attack occurs, the data may face the risk of being leaked. Additionally, as time goes on, the number and types of stored logs continue to increase, making the data a potential target for attackers. For example, the attackers may analyze a large number of processed logs to predict original logs, posing a threat to data security.

In view of this, an embodiment of the present disclosure provides a solution for processing a log. In the solution, after generating a log, a client (or an application) may acquire a first key, and the first key is a time-bound key, associated with a first time point. Then, the client may encrypt the log to generate an encrypted log. In a log encryption process, the client may use the first key to directly or indirectly encrypt the log. Then, the client may send the encrypted log to the server side. After the server side receives the encrypted log, if an access request for the encrypted log is received at a second time point, a time difference between the first time point bound to the first key and the second time point may be determined. If the time difference is less than a preset time window length, the server side may decrypt the encrypted log using a second key, where the second key may be the first key sent from the client to the server side or a key corresponding to the first key that is stored at the server side.

Through the method, after the log is encrypted, the log can be successfully decrypted only when the log is accessed within a preset time window. Otherwise, the log cannot be decrypted. Therefore, a timely analysis on application performance and the operation records can be ensured, and meanwhile logs that may include sensitive data can be expired within the shortest possible time, thereby enhancing data security.

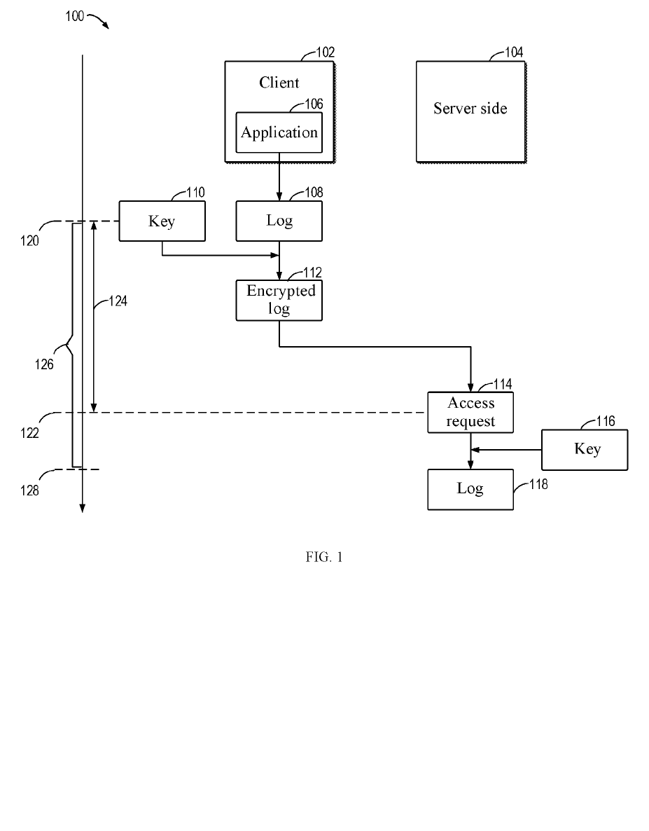

FIG. 1 illustrates a schematic diagram of an example environment 100 where a plurality of embodiments of the present disclosure may be implemented. As shown in FIG. 1, the environment 100 includes a client 102 and a server side 104.The client 102 may be any device that can run an application. For example, the client 102 may be a mobile phone, a tablet computer, a smart wearable device, a personal computer, a desktop computer, a laptop computer, an Internet-of-things device, or the like. The server side 104 may be any device with a computing capability or a processing capability. For example, the server side 104 may be a local server, a cloud server, a virtual server, a personal computer, a desktop computer, a laptop computer, or the like.

In the environment 100, an application 106 runs on the client 102, and the application 106 may be any application that generates a log in an operation process. For example, the application 106 may be a video application, a life service application, a social application, a music application, or the like. The log is a record file automatically generated in the operation process of the application, typically including application states, operations, error information, performance metrics, user behaviors, system events, etc. The log may assist development engineers, maintenance engineers, and data analysis engineers in understanding an application working state, troubleshooting issues, and making corresponding decisions.

In the environment 100, the application106 may generate a log 108 in the operation process. The log 108 may include a plurality of log entries of the same or different types. For example, the log 108 may include an information log recording normal operation events in the application, an error log recording errors (e.g., crashes and exceptions) encountered in the operation process of the application, a performance log recording the application performance, etc.

After the log 108 is generated, to enhance log security, the client 102 may encrypt the log 108.In the environment 100, the client 102 may acquire a key 110.In some embodiments, the key 110 may be generated at the server side 104.The client 102 may acquire the key 110 from the server side 104.In some embodiments, the key 110 may be generated at the client 102 in response to the generation of the log 108.In some embodiments, the key 110 may be pre-stored at the client 102.In some embodiments, the key 110 may be a public key for asymmetric encryption. In some embodiments, the key 110 may be a key for symmetric encryption.

In the environment 100, the key 110 may be a time-bound key. The time-bound key refers to the key being associated with a specific time point or timestamp. When accessing the key, a timestamp bound to the key may be determined, and after the key and the timestamp are bound, the bound timestamp cannot be modified. In the environment 100, the key 110 is bound to a time point 120.In some embodiments, when the key 110 is received from the client 102 to the server side 104, the time point 120 may be time when the server side 104 sends the key 110 to the client 102.In some embodiments, the time point 120 may be time from time when the log 108 is generated to time when the server side 104 sends the key 110 to the client 102.In some embodiments, the time point 120 may be time when the log 108 is generated. In some embodiments, the time point 120 may be time when the key 110 is generated.

In the environment 100, after acquiring the key 110, the client 102 may encrypt the log 108 to generate an encrypted log 112. In the encryption process, the client 102 may use the key 110 to directly or indirectly encrypt the log 108.In some embodiments, the client 102 may directly use the key 110 to encrypt data of the log 108 to generate the encrypted log 112.In some embodiments, the client 102 may generate a temporary session key for the log 108 and use the session key to encrypt the data of the log 108. Then, the client 102 may use the key 110 to encrypt the session key. The process may be referred as indirect use the key 110 for encrypting the log 108.

In the environment 100, the client 102 may send the encrypted log 112 to the server side 104.After receiving the encrypted log 112, the server side 104 may store the encrypted log 112.At a time point 122, the server side 104 may receive an access request 114 for the encrypted log 112 (e.g., from a data analysis system).Since the encrypted log 112 is encrypted using the key 110 and the key 110 is bound to the time point 120, the server side 104 may determine a time difference 124 between the time point 120 bound to the key 110 and the time point 122 when the access request 114 is received.

In the environment 100, a preset time window 126 has a fixed window length. The server side 104 may compare the time difference 124 with the preset time window 126.If the time difference 124 meets (e.g., is less than or equal to) the preset time window 126, the server side 104 may use a key 116 to decrypt the encrypted log 112, to acquire a log 118 (i.e., the log 108). In the embodiment where the key 110 is the public key for asymmetric encryption, the key 116 may be a private key corresponding to the key 110 that is stored at the server side 104.In the embodiment where the key 110 is the key for symmetric encryption, the key 116 may be a key the same as the key 110 stored at the server side 104, or a key corresponding to the key 110 that is used to decrypt the encrypted log 112.However, in the environment 100, the key 116 may be expired or destroyed after the preset time window 126 starting from the time point 120, and therefore the server side 104 cannot acquire a valid key to decrypt the encrypted log 112 when receiving the access request after the time point 128.Therefore, when the time difference 124 does not meet (e.g., is greater than) the preset time window 126, the server side 104 may reject the access request 114 (e.g., due to the inability to acquire the valid key 116), thereby preventing access to logs stored beyond the preset time window 126.

Through the method, after the log 108 is encrypted, the encrypted log 112 can be successfully decrypted only when the encrypted log 112 is accessed within the preset time window 126. Otherwise, the encrypted log 112 cannot be decrypted. Therefore, a timely analysis on application performance and operation records can be ensured, and meanwhile logs that may include sensitive data can be expired within the shortest possible time, thereby enhancing data security.

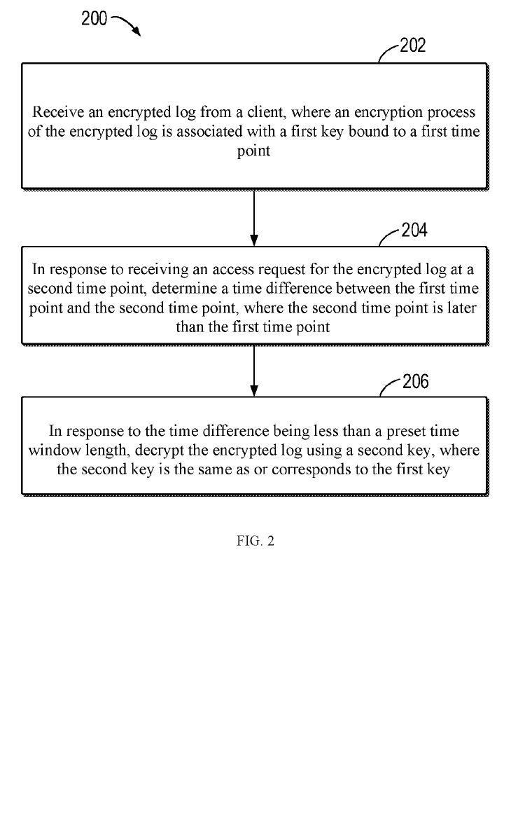

FIG. 2 illustrates a flowchart of a method 200 for processing a log according to some embodiments of the present disclosure. The method 200 may be performed by a server side. For example, the method 200 may be performed by the server side 104 in FIG. 1. As shown in FIG. 2, at a block 202, the server side may receive an encrypted log from a client, where an encryption process of the encrypted log is associated with a first key bound to a first time point. For example, in the environment 100 shown in FIG. 1, the client 102 may send the encrypted log 112 to the server side 104.After receiving the encrypted log 112, the server side 104 may store the encrypted log 112.In the encryption process of the encrypted log 112, the key 110 is used to directly or indirectly encrypt the log 108.Additionally, the key 110 is bound to the time point 120.The time point 120 may be, for example, time when the server side 104 sends the key 110 to the client 102, time from time when the log 108 is generated to time when the server side 104 sends the key 110 to the client 102, time when the log 108 is generated, time when the key 110 is generated, or the like.

At a block 204, in response to receiving an access request for the encrypted log at a second time point, the server side may determine a time difference between the first time point and the second time point, where the second time point is later than the first time point. For example, in the environment 100 shown in FIG. 1, at the time point 122, the server side 104 may receive the access request 114 for the encrypted log 112.Then, the server side 104 may determine the time difference 124 between the time point 120 bound to the key 110 and the time point 122 when the access request 114 is received.

At a block 206, in response to the time difference being less than a preset time window length, the server side may use a second key to decrypt the encrypted log, where the second key is the same as or corresponds to the first key. For example, in the environment 100 shown in FIG. 1, the preset time window 126 has the fixed window length. The server side 104 may compare the time difference 124 with the preset time window 126.If the time difference 124 is less than the preset time window 126, the server side 104 may use the key 116 to decrypt the encrypted log 112, to acquire the log 118 (i.e., the log 108). The key 116 may be a private key corresponding to the key 110 that is stored at the server side 104, or a key the same as the key 110 stored at the server side 104, or a key corresponding to the key 110 that is used to decrypt the encrypted log 112.

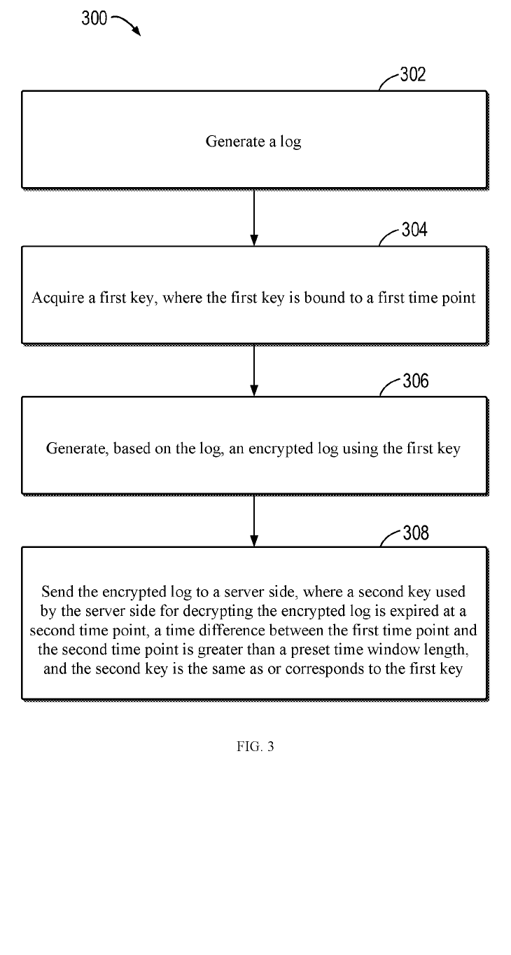

FIG. 3 illustrates a flowchart of another method 300 for processing a log according to some embodiments of the present disclosure. The method 200 may be performed by a client. For example, the method 200 may be performed by the client 102 in FIG. 1. As shown in FIG. 3, at a block 302, the client may generate a log. For example, in the environment 100 shown in FIG. 1, the client 102 may generate the log 108 of the application 106.

At a block 304, the client may acquire a first key, where the first key is bound to a first time point. For example, in the environment 100 shown in FIG. 1, the client 102 may acquire the key 110.The key 110 is a key bound to time, and may be bound to the time point 120.

At a block 306, the client may use, based on the log, the first key to generate an encrypted log. For example, in the environment 100 shown in FIG. 1, the client 102 may encrypt the log 108 to generate the encrypted log 112. In the encryption process, the client 102 may use the key 110 to directly or indirectly encrypt the log 108.In some embodiments, the client 102 may directly use the key 110 to encrypt data of the log 108 to generate the encrypted log 112. In some embodiments, the client 102 may generate a temporary session key for the log 108 and use the session key to encrypt the data of the log 108.Then, the client 102 may use the key 110 to encrypt the session key.

At a block 308, the client may send the encrypted log to a server side, where a second key used by the server side for decrypting the encrypted log is expired at a second time point, a time difference between the first time point and the second time point is greater than a preset time window length, and the second key is the same as or corresponds to the first key. For example, in the environment 100 shown in FIG. 1, the client 102 may send the encrypted log 112 to the server side 104.The key 116 is a key for decrypting the encrypted log 112.For example, the key 116 may be a private key corresponding to the key 110 that is stored at the server side 104, or a key the same as the key 110 stored at the server side 104, or a key corresponding to the key 110 that is used to decrypt the encrypted log 112.The key 116 is expired after the preset time window 126 starting from the time point 120, and therefore the server side 104 cannot use the key 116 to decrypt the encrypted log 112.

Through the method, after the log is encrypted, the log can be successfully decrypted only when the log is accessed within a preset time window. Otherwise, the log cannot be decrypted. Therefore, a timely analysis on application performance and operation records can be ensured, and meanwhile logs that may include sensitive data can be expired within the shortest possible time, thereby enhancing data security.

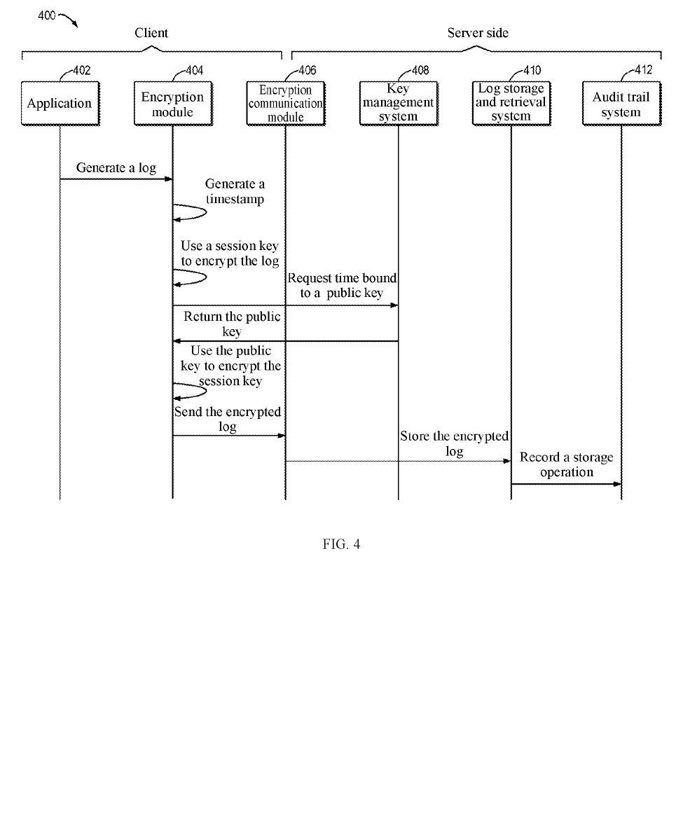

FIG. 4 illustrates a schematic diagram of an example 400 of a process of sending an encrypted log to a server side from a client according to some embodiments of the present disclosure. In the example 400, the client includes an application 402 and an encryption module 404. The server side includes a key management system 408, a log storage and retrieval system 410, and an audit trail system 412.Additionally, the example 400 further includes an encryption communication module 406 for achieving an encrypted communication between the client and the server side. The application 402 may generate a log in an operation process. For example, the application 402 may be the application 106 in FIG. 1.

The encryption module 404 may be configured to preliminary encrypt the log and add a timestamp at the client. In some embodiments, the encryption module 404 may use an AES-256 algorithm to encrypt the content of the log, and use an SHA-256 algorithm to generate a unique identifier of the log.In some embodiments, the encryption module 404 may use a network time protocol (NTP) to ensure the accuracy of the timestamp. NTP is a protocol used to synchronize time across computer networks, and the encryption module 404 may be connected to a reliable time source server through the network, thereby maintaining accurate time at the client side. Additionally, the encryption module 404 may use a secure random number to generate a temporary session key, and use an asymmetric encryption algorithm to encrypt the temporary session key.

The key management system 408 of the server side may be configured to manage and distribute encryption keys. The key management system 408 may store a master key through a hardware security module (HSM). The HSM is a specialized physical device used to protect and manage sensitive information such as the encryption keys. The HSM is equipped with a tamper-resistant mechanism, a strict access control, and dedicated encryption hardware for executing encryption operations. By storing the master key in the HSM, the master key may be prevented from being leaked due to software vulnerabilities, malicious attacks, or improper operations. Since the HSM is designed to have strict protective measures for links such as key storage and usage, for example, the HSM may limit access to the master key only to authorized entities through specific interfaces and verification processes, thereby enhancing the security of an entire encryption system.

Additionally, the key management system 408 may generate keys using a time-based one-time password (TOTP) algorithm. The TOTP is a dynamic password generation algorithm that may generate temporary passwords valid for only a short period based on current time and a pre-shared key. Then, the key management system 408 may use a Shamir's secret sharing algorithm to split the key into a plurality of shares, thereby storing the shares at different positions. Additionally, the key management system 408 may also use a key rotation mechanism to periodically change the encryption keys. The key management system 408 may also use two-factor authentication to control access, thereby enhancing key access control, and rejecting unauthorized access. By integrally using a plurality of technical means, the key management system 408 can improve key security and protect data security in a plurality of steps such as key storage, generation, splitting, and access control.

The log storage and retrieval system 410 may be configured to store the encrypted log and provide a retrieval service for the log. The log storage and retrieval system 410 may store a large volume of log data by using a distributed file system. Additionally, the log storage and retrieval system 410 may retrieve the log identifier and the timestamp, thereby improving the log retrieving efficiency.

The audit trail system 412 may be configured to record all operations for the log, thereby ensuring system auditability. The audit trail system 412 may record the log operations in detail based on an open web application security project (OWASP) standard. Additionally, the audit trail system 412 may reduce influences on main system performance through an asynchronous log writing mechanism. The audit trail system 412 may also optimize use of a storage space by using log compression and archiving functions. Additionally, the audit trail system 412 may also provide role-based access control for an audit log. Different personnel have varying access permissions to the audit log. The system may verify an identity and a role of an account accessing the audit log and determine, based on a predetermined rule, whether to grant access to the audit log, thereby preventing unauthorized access and ensuring log security.

As shown in FIG. 4, the application 402 may generate the log in the operation process. The encryption module 404 may capture a log that needs to be recorded, and generate a unique log identifier based on the log. Additionally, the encryption module 404 may also generate a current timestamp (e.g., the timestamp may correspond to the first time point described above). Then, the encryption module 404 may generate a temporary session key (e.g., by generating a secure random number), and use the session key to preliminarily encrypt the log to generate an encrypted log.

After the encrypted log is generated, the encryption module 404 may send a key acquisition request to the server side, to request the acquisition of a public key bound to time, where the request may include the generated timestamp. After receiving the key acquisition request, the server side may generate a public key and a private key for asymmetric encryption, and bind the public key and the private key with the timestamp in the key acquisition request. The public key bound to the time may be sent from the server side to the client via the encryption communication module 406, and the private key may be stored at the server side.

After the client acquires the public key bound to the time, the encryption module 404 may use the public key to encrypt the session key previously generated for log encryption, thereby generating an encrypted session key. Then, the client may send the encrypted log content, the encrypted log identifier, the encrypted timestamp, and the encrypted session key to the server side. After receiving the encrypted log, the server side may store the encrypted log in the log storage and retrieval system 410, and the audit trail system 412 records the storage operation.

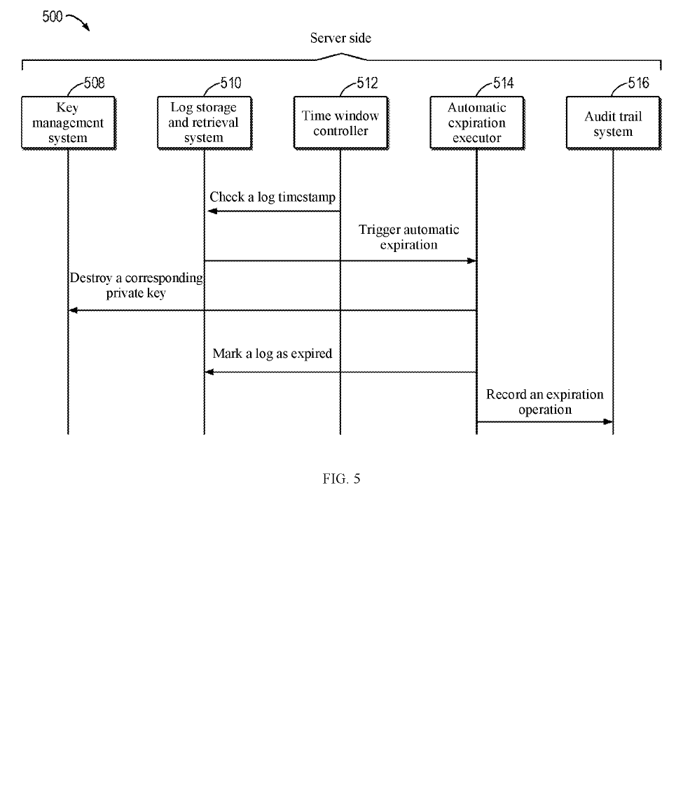

FIG. 5 illustrates a schematic diagram of an example 500 of a process for periodically checking a timestamp associated with a log at a server side according to some embodiments of the present disclosure. In the example 500, the server side includes a key management system 508 (e.g., the key management system 408 in FIG. 4), a log storage and retrieval system 510 (e.g., the log storage and retrieval system 410 in FIG. 4), a time window controller 512, an automatic expiration executor 514, and an audit trail system 516 (e.g., the audit trail system 412 in FIG. 4).

The time window controller 512 may be configured to control an accessible time window for the log according to a preset rule. In some embodiments, the time window controller 512 may adjust the accessible time window based on a log type. For example, a user operation log may include a user operation record, a click record, a page access record, etc. Even after desensitization, the log may still include data associated with the user, and therefore a length of the time window may be set to a smaller value (e.g., 30 days or less). For another example, a system running log may include service states, error reports, performance metrics, etc. The system running log is used for troubleshooting system issues or evaluating system performance, and therefore compared to the user operation log, the time window for the system running log may have a high value (e.g., 3 months or more). Further, a time window for the system running log may be adjusted based on the complexity of the system. Through the method, the length of the time window can be dynamically determined, the flexibility of the system is improved, and different log analysis requirements are satisfied.

The automatic expiration executor 514 may be configured to invalid the log and a corresponding key (e.g., a private key stored at the server side) after the time window is ended. The automatic expiration executor 514 may use a timed task scheduling system and an asynchronous processing mechanism to improve the system performance. Additionally, the automatic expiration executor 514 may use a secure erase algorithm to ensure that the key is thoroughly deleted. Additionally, the automatic expiration executor 514 may use a transaction mechanism to ensure the atomicity of an expiration operation and use an expiration confirmation mechanism to prevent expiration failures due to system failures.

As shown in FIG. 5, the time window controller 512 at the server side may periodically check the timestamp associated with the log stored in the log storage and retrieval system 510, or a timestamp bound to a private key of a session key for decrypting the log. If the accessible time window for the log has been ended or a time difference between a current time point and the timestamp bound to the private key is greater than the length of the accessible time window, the automatic expiration executor 514 may destroy the private key stored in the key management system 508, thereby ensuring that the session key for decrypting the encrypted log cannot be decrypted, and then ensuring that the encrypted log cannot be decrypted. Since the private key is destroyed, the automatic expiration executor 514 may mark the corresponding log as expired. After the automatic expiration executor 514 expires the private key and the log, the audit trail system 516 may record this expiration operation.

In some embodiments, the server side may periodically check a time difference between expiration time of the log and the current time. If the time difference is greater than a preset threshold, the server side may delete the expired log from the log storage and retrieval system 510.Through the method, the log security can be further improved, and the storage space can also be saved.

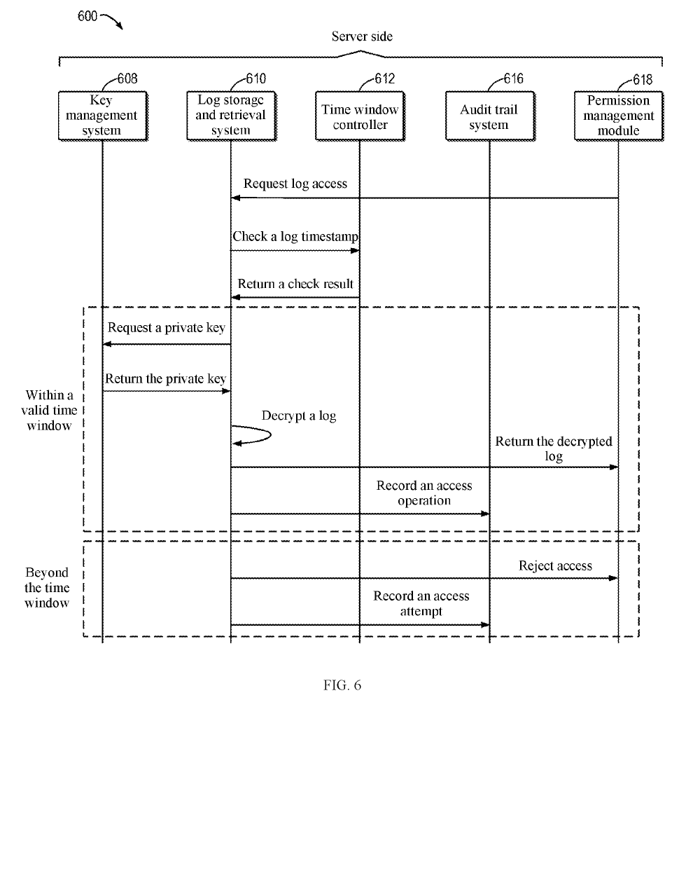

FIG. 6 illustrates a schematic diagram of an example 600 of a process for processing a log access request at a server side according to some embodiments of the present disclosure. As shown in FIG. 6, in the example 600, the server side includes a key management system 608 (e.g., the key management system 508 in FIG. 5), a log storage and retrieval system 610 (e.g., the log storage and retrieval system 510 in FIG. 5), a time window controller 612 (e.g., the time window controller 512 in FIG. 5), an audit trail system 616 (e.g., the audit trail system 516 in FIG. 5), and a permission management module 618.

The permission management module 618 may be configured to manage and control access permissions to various parts of the system. For example, the permission management module 618 may be a permission system based on a role-based access control (RBAC) model. The permission management module 618 may use OAuth 2.0 and OpenID Connect to implement identity authentication and authorization. Additionally, the permission management module 618 may ensure that the user only accesses necessary resources based on the principle of least privilege. The permission management module 618 may also adopt a dynamic permission allocation mechanism to support temporary permission granting and revocation. Additionally, the permission management module 618 may also have a permission change audit function.

As shown in FIG. 6, after permission verification, the permission management module 618 may request access to an encrypted log in the log storage and retrieval system 610.The time window controller 612 may check a timestamp associated with the log stored in the log storage and retrieval system 610, or a timestamp bound to a private key of a session key for decrypting the log.

If the time of the request for log access is within a valid time window of the log or a time difference between the time of the request for log access and the timestamp bound to the private key is less than a length of an accessible time window, the log storage and retrieval system 610 may acquire the private key of the session key for decrypting the log from the key management system 608.Then, the log storage and retrieval system 610 may use the acquired private key to decrypt the session key of the log, and use the decrypted session key to decrypt the encrypted log. The decrypted log may be sent to the permission management module 618.The permission management module 618 may provide the decrypted log to an authorized user for viewing and analysis. An access operation of the authorized user for the log may be recorded in the audit trail system 616.

If the time of the request for log access exceeds the valid time window of the log, or the time difference between the time of the request for log access and the timestamp bound to the private key is greater than the length of the accessible time window, it indicates that the log and the corresponding private key are expired. In this case, the request for log access may be rejected, and the permission management module 618 may notify authorized personnel of the inability to access the log. Additionally, the attempted log access that is currently rejected may be recorded in the audit trail system 616.

According to the solution provided in this embodiment of the present disclosure, storage time of the sensitive data can be significantly shortened, and the risk of data leakage is effectively reduced. By improving an automation level of log management, potential risks caused by manual operations can be reduced, system security and reliability are enhanced, and potential attacks and data misuse are resisted. Additionally, the solution can also improve the flexibility of a log expiration mechanism, and satisfy analysis requirements for different types of logs. While protecting data security, the solution can also ensure that application developers and data analysis engineers can perform necessary performance analysis and problem diagnosis. Additionally, by recording various operations on the log, system auditability can be achieved, thereby allowing a system administrator or an automatic management system to find potential issues in the system in time based on audit logs, and then further enhancing system reliability and security.

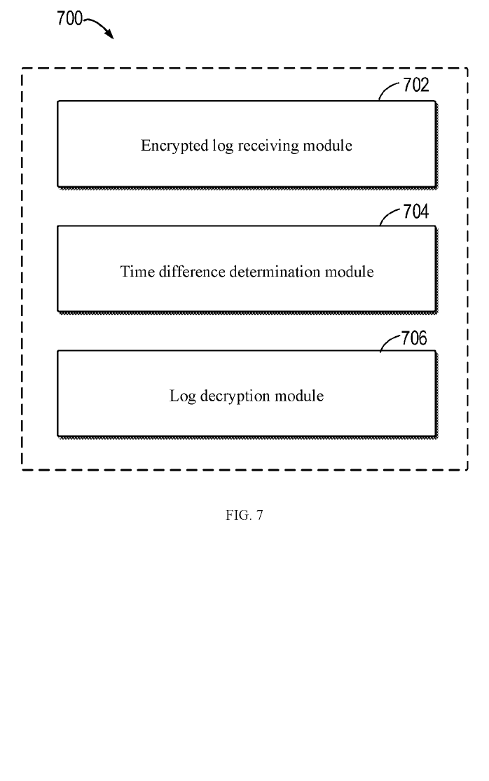

FIG. 7 illustrates a block diagram of an apparatus 700 for processing a log according to some embodiments of the present disclosure. As shown in FIG. 7, the apparatus 700 includes an encrypted log receiving module 702, configured to receive an encrypted log from a client, where an encryption process of the encrypted log is associated with a first key bound to a first time point. The apparatus 700 further includes a time difference determination module 704, configured to determine, in response to receiving an access request for the encrypted log at a second time point, a time difference between the first time point and the second time point, where the second time point is later than the first time point. Additionally, the apparatus 700 further includes a log decryption module 706, configured to use, in response to the time difference being less than a preset time window length, a second key to decrypt the encrypted log, where the second key is the same as or corresponds to the first key.

In some embodiments, the first key is a public key for asymmetric encryption, and the second key is a private key corresponding to the public key.

In some embodiments, the apparatus 700 further includes: a time binding module, configured to bind the first key and the second key to the first time point in response to receiving a key acquisition request from the client; a first key sending module, configured to send the first key to the client; and a second key storage module, configured to store the second key.

In some embodiments, the first key is used to encrypt a third key at the client, the third key is generated at the client, and the third key is used to encrypt a log at the client to generate an encrypted log.

In some embodiments, the apparatus 700 further includes: a third key receiving module, configured to receive the encrypted third key from the client. The step of using a second key to decrypt the encrypted log uses: a third key decryption module, configured to use the second key to decrypt the encrypted third key; and an encrypted log decryption module, configured to use the third key to decrypt the encrypted log.

In some embodiments, the time difference is a first time difference. The apparatus 700 further includes: a second time difference determination module, configured to determine a second time difference between the first time point and a third time point; and a second time difference use module, configured to destroy the second key at the third time point to expire the encrypted log in response to the second time difference being not less than the preset time window length.

In some embodiments, the apparatus 700 further includes: a third time difference determination module, configured to determine a third time difference between the third time point and a fourth time point; and a third time difference use module, configured to delete the encrypted log in response to the third time difference being greater than the preset threshold.

In some embodiments, the apparatus 700 further includes: a log type determination module, configured to determine a log type of the encrypted log; and a time window determination module, configured to determine a corresponding preset time window length based on the log type.

In some embodiments, the apparatus 700 further includes: a storage operation record module, configured to record a storage operation in response to storing the encrypted log at the server side; an access request record module, configured to record an access request in response to decrypting the encrypted log; an expiration operation record module, configured to record an expiration operation in response to encrypted log expiration; and an access attempt record module, configured to record an access attempt in response to receiving an access request for the expired encrypted log.

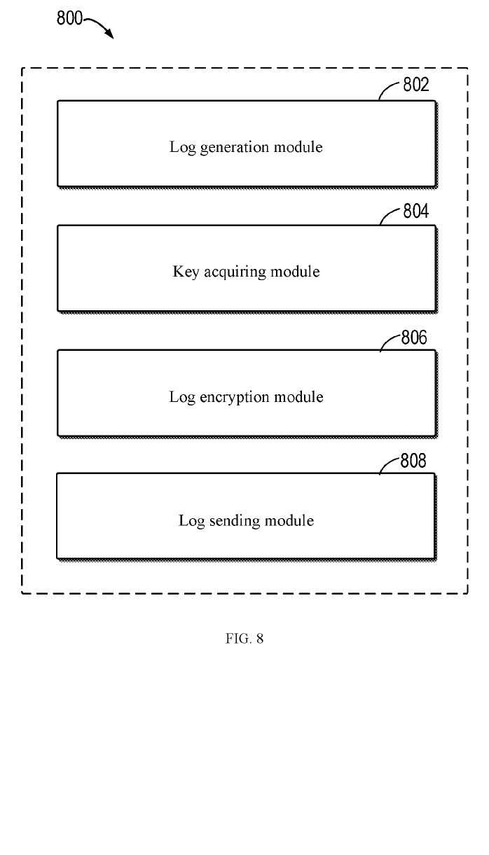

FIG. 8 illustrates a block diagram of an apparatus 800 for processing a log according to some embodiments of the present disclosure. As shown in FIG. 8, the apparatus 800 includes a log generation module 802, configured to generate a log. The apparatus 800 further includes a key acquiring module 804, configured to acquire a first key, where the first key is bound to a first time point. The apparatus 800 further includes a log encryption module 806, configured to use, based on the log, the first key to generate an encrypted log. Additionally, the apparatus 800 further includes a log sending module 808, configured to send the encrypted log to a server side, where a second key used by the server side for decrypting the encrypted log is expired at a second time point, a time difference between the first time point and the second time point is greater than a preset time window length, and the second key is the same as or corresponds to the first key.

In some embodiments, the first key is a public key, and the second key is a private key corresponding to the public key.

In some embodiments, the key acquiring module 804 includes: a request sending module, configured to send a key acquiring request to the server side; and a first key receiving module, configured to receive the first key from the server side.

In some embodiments, the log encryption module 806 includes: a third key generation module, configured to generate a third key; a third key use module, configured to encrypt the log through the third key to generate the encrypted log; and a third key encryption module, configured to encrypt the third key through the first key to generate an encrypted third key, where the second key is used to decrypt the encrypted third key. The apparatus 800 further includes: a third key sending module, configured to send the encrypted third key to the server side.

It should be understood that by using the apparatus 700 and the apparatus 800 in the present disclosure, at least one of the many advantages capable of being implemented in the method or the process described above may be achieved. For example, after the log is encrypted, the log can be successfully decrypted only when the log is accessed within a preset time window. Otherwise, the log cannot be decrypted. Therefore, a timely analysis on application performance and operation records can be ensured, and meanwhile logs that may include sensitive data can be expired within the shortest possible time, thereby enhancing data security.

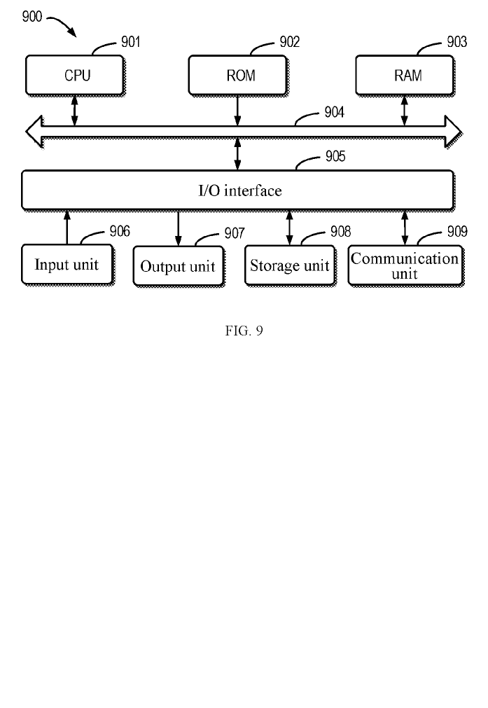

FIG. 9 illustrates a block diagram of a device 900 capable of implementing a plurality of embodiments of the present disclosure. The device 900 may be, for example, a client 102 or a server side 104 shown in FIG. 1.As shown in FIG. 9, the device 900 includes a central processing unit (CPU) and/or a graphics processing unit (GPU) 901, which may perform various suitable actions and processing according to computer program instructions stored in a read-only memory (ROM) 902 or computer program instructions loaded from a storage unit 908 into a random access memory (RAM) 903.The RAM 903 may also store various programs and data required for the operation of the device 900.The CPU/GPU 901, the ROM 902, and the RAM 903 are connected to one another through a bus 904.An input/output (I/O) interface 905 is also connected to the bus 904.Although not shown in FIG. 9, the device 900 may also include a coprocessor.

A plurality of components in the device 900 are connected to the I/O interface 905, including an input unit 906 such as a keyboard and a mouse; an output unit 907 such as various types of displays and speakers; the storage unit 908 such as a disk and an optical disk; and a communication unit 909 such as a network card, a modem, and a wireless communication transceiver. The communication unit 909 allows the device 900 to exchange information/data with other devices through a computer network such as the Internet, and/or various telecommunication networks.

The various methods or processes described above may be performed by the CPU/GPU 901.For example, in some embodiments, the method may be implemented as a computer software program that is tangibly included in a machine-readable medium, such as the storage unit 908.In some embodiments, part or all of the computer program may be loaded and/or installed onto the device 900 via the ROM 902 and/or the communication unit 909. When the computer program is loaded onto the RAM 903 and executed by the CPU/GPU 901, one or more of steps or actions of the methods or the processes described above may be performed.

In some embodiments, the methods and the processes described above may be implemented as a computer program product. The computer program product may include a computer-readable storage medium carrying computer-readable program instructions for performing various aspects of the present disclosure.

The computer-readable storage medium may be a tangible device that may retain and store instructions used by an instruction-executing device. The computer-readable storage medium may be, for example, but is not limited to, an electric storage device, a magnetic storage device, an optical storage device, an electromagnetic storage device, a semiconductor storage device, or any suitable combination of the above. More specific examples (a non-exhaustive list) of the computer-readable storage medium include: a portable computer disk, a hard drive, a random access memory (RAM), a read-only memory (ROM), an erasable programmable read-only memory (EPROM or a flash memory), a static random access memory (SRAM), a portable compact disk read-only memory (CD-ROM), a digital versatile disc (DVD), a memory stick, a floppy disk, a mechanical encoding device, such as a punch card or a raised structure in a groove with instructions stored therein, and any suitable combination of the above. The computer-readable storage medium used herein is not to be interpreted as transient signals, such as radio waves or other freely propagating electromagnetic waves, electromagnetic waves propagated through waveguides or other transmission media (e.g., light pulses through fiber-optic cables), or electrical signals transmitted through wires.

The computer-readable program instructions described herein may be downloaded from the computer-readable storage medium to various computing/processing devices or downloaded to an external computer or an external storage device through a network, such as the Internet, a local area network, a wide area network, and/or a wireless network. The network may include a copper transmission cable, fiber optic transmission, wireless transmission, a router, a firewall, a switch, a gateway computer, and/or an edge server. A network adapter card or a network interface in each computing/processing device receives the computer-readable program instructions from the network and forwards the computer-readable program instructions for storage in the computer-readable storage medium in each computing/processing device.

The computer program instructions for performing the operations of the present disclosure may be assembly instructions, instruction set architecture (ISA) instructions, machine instructions, machine-dependent instructions, microcode, firmware instructions, state setting data, or source code or object code written in any combination of one or more programming languages, where the programming languages include object-oriented programming languages and conventional procedural programming languages. The computer-readable program instructions may be executed entirely on a user computer, partly on the user computer, as a stand-alone software package, partly on the user computer and partly on a remote computer, or entirely on the remote computer or the server. In the case of the remote computer, the remote computer may be connected to the user computer through any type of network, including a local area network (LAN) or a wide area network (WAN), or may be connected to the external computer (e.g., connected through the Internet with the aid of an Internet service provider).In some embodiments, an electronic circuit, such as a programmable logic circuit, a field programmable gate array (FPGA), or a programmable logic array (PLA), is customized by utilizing state information of the computer-readable program instructions. The electronic circuit may execute the computer-readable program instructions so as to implement various aspects of the present disclosure.

These computer-readable program instructions may be provided to a processing unit of a general-purpose computer, a special-purpose computer, or another programmable data processing apparatus, thereby producing a machine, such that these instructions, when executed by the processing unit of the computer or other programmable data processing apparatus, produce an apparatus for implementing functions/actions specified in one or more blocks in the flowcharts and/or the block diagrams. These computer-readable program instructions may also be stored in the computer-readable storage medium, and these instructions cause the computer, the programmable data processing apparatus, and/or another device to operate in a specific method; and therefore, the computer-readable medium having instructions stored therein includes a product that includes instructions for implementing various aspects of the functions/actions specified in one or more blocks in the flowcharts and/or the block diagrams.

The computer-readable program instructions may also be loaded to the computer, other programmable data processing apparatus, or other device, such that a series of operating steps are performed on the computer, other programmable data processing apparatus, or other device to produce a computer-implemented process, and accordingly, the instructions executed on the computer, other programmable data processing apparatus, or other device implement the functions/actions specified in one or more blocks in the flowcharts and/or the block diagrams.

The flowcharts and the block diagrams in the accompanying drawings illustrate the possibly implemented system architectures, functions, and operations of the device, the method, and the computer program product according to the plurality of embodiments of the present disclosure. In this regard, each block in the flowcharts or the block diagrams may represent a module, a program segment, or a portion of instruction, and the module, the program segment, or the portion of instruction includes one or more executable instructions for implementing specified logical functions. In some alternative implementations, functions marked in the blocks may also occur in an order different from that marked in the accompanying drawings. For example, two successive blocks may actually be executed in parallel substantially, and sometimes may also be executed in a reverse order, depending on functions involved. It should be further noted that each block in the block diagrams and/or the flowcharts, as well as a combination of the blocks in the block diagrams and/or the flowcharts may be implemented by using a dedicated hardware-based system that executes specified functions or actions, or using a combination of dedicated hardware and computer instructions.

The embodiments of the present disclosure have been described above. The above description is exemplary, rather than exhaustive, and is not limited to the disclosed various embodiments. Numerous modifications and variations are apparent to those of ordinary skill in the art without departing from the scope and spirit of the described embodiments. The selection of the terms as used herein is intended to best explain the principles and practical applications of the various embodiments, or improvements to technologies on the market, or to allow other persons of ordinary skill in the art to understand the various embodiments disclosed herein.

We claim:

1. A method for processing a log, comprising:
receiving an encrypted log from a client, an encryption process of the encrypted log being associated with a first key bound to a first time point;
determining, in response to receiving an access request for the encrypted log at a second time point, a time difference between the first time point and the second time point, the second time point being later than the first time point; and
decrypting, in response to the time difference being less than a preset time window length, the encrypted log using a second key, the second key being the same as or corresponding to the first key.

2. The method according to claim 1, wherein the first key is a public key for asymmetric encryption, and the second key is a private key corresponding to the public key.

3. The method according to claim 2, further comprising:
binding the first key and the second key to the first time point in response to receiving a key acquisition request from the client;
sending the first key to the client; and
storing the second key.

4. The method according to claim 3, wherein the first key is used to encrypt a third key at the client, the third key is generated at the client, and the third key is used to encrypt a log at the client to generate the encrypted log.

5. The method according to claim 4, further comprising:
receiving the encrypted third key from the client;
wherein decrypting the encrypted log using the second key comprises:
decrypting the encrypted third key using the second key; and
decrypting the encrypted log using the third key.

6. The method according to claim 1, wherein the time difference is a first time difference, and the method further comprises:
determining a second time difference between the first time point and a third time point; and
invalidating the encrypted log by destroying the second key at the third time point in response to the second time difference being not less than the preset time window length.

7. The method according to claim 6, further comprising:
determining a third time difference between the third time point and a fourth time point; and
deleting the encrypted log in response to the third time difference being greater than a preset threshold.

8. The method according to claim 1, further comprising:
determining a log type of the encrypted log; and
determining a corresponding preset time window length based on the log type.

9. The method according to claim 1, further comprising:
recording a storage operation in response to storing the encrypted log at a server;
recording the access request in response to the encrypted log being decrypted;
recording an invalidation operation in response to the encrypted log being invalidated; and
recording an access attempt in response to receiving an access request for the invalidated encrypted log.

10. A method for protecting a log, comprising:
generating a log;
acquiring a first key, the first key being bound to a first time point;
generating an encrypted log based on the log and using the first key; and
sending the encrypted log to a server, wherein a second key used by the server for decrypting the encrypted log is invalidated at a second time point, a time difference between the first time point and the second time point is greater than a preset time window length, and the second key is the same as or corresponds to the first key.

11. The method according to claim 10, wherein the first key is a public key, and the second key is a private key corresponding to the public key.

12. The method according to claim 11, wherein acquiring the first key comprises:
sending a key acquisition request to the server; and
receiving the first key from the server.

13. The method according to claim 12, wherein generating the encrypted log based on the log and using the first key comprises:
generating a third key;
encrypting the log using the third key, to generate the encrypted log; and
encrypting the third key using the first key to generate the encrypted third key, wherein the second key is used to decrypt the encrypted third key, and
wherein the method further comprises:
sending the encrypted third key to the server.

14. An electronic device, comprising:
a processor; and
a memory coupled with the processor, the memory having instructions stored therein, and the instructions, when executed by the processor, causing the electronic device to:
receiving an encrypted log from a client, an encryption process of the encrypted log being associated with a first key bound to a first time point;
determining, in response to receiving an access request for the encrypted log at a second time point, a time difference between the first time point and the second time point, the second time point being later than the first time point; and
decrypting, in response to the time difference being less than a preset time window length, the encrypted log using a second key, the second key being the same as or corresponding to the first key.

15. The electronic device according to claim 14, wherein the first key is a public key for asymmetric encryption, and the second key is a private key corresponding to the public key.

16. The electronic device according to claim 15, further comprising instructions to:
bind the first key and the second key to the first time point in response to receiving a key acquisition request from the client;
send the first key to the client; and
store the second key.

17. The electronic device according to claim 16, wherein the first key is used to encrypt a third key at the client, the third key is generated at the client, and the third key is used to encrypt a log at the client to generate the encrypted log.

18. The electronic device according to claim 14, wherein the time difference is a first time difference, further comprising instructions to:
determine a second time difference between the first time point and a third time point; and
invalidate the encrypted log by destroying the second key at the third time point in response to the second time difference being not less than the preset time window length.

19. The electronic device according to claim 14, further comprising instructions to:
determine a log type of the encrypted log; and
determine a corresponding preset time window length based on the log type.

20. The electronic device according to claim 14, further comprising instructions to:
record a storage operation in response to storing the encrypted log at a server;
record the access request in response to the encrypted log being decrypted;
record an invalidation operation in response to the encrypted log being invalidated; and
record an access attempt in response to receiving an access request for the invalidated encrypted log.
